(19) United States
(12) Patent Application Publication
(10) Pub. No.: US 2007/0222165 A1
(43) Pub. Date: Sep. 27, 2007

(54) Multi-wheeled hub and cargo-carrying apparatuses comprising same

(76) Inventor: Thomas Leonard Hope, Kings Lynn (GB)

Correspondence Address: David O. Simmons;Galasso & Associates LP, P.O. Box 26503, Austin, TX, 78755-0503, US

(21) Appl. No.: 11/389,641

(22) Filed: Mar. 24, 2006

(51) Int. Cl. B62B 5/02

(52) U.S. Cl. 280/5.26

(57) ABSTRACT

A multi-wheel hub assembly comprises a central hub and at least three wheels rotatably attached to the central hub. The central hub is configured for being rotatably attached to a support assembly. The central hub includes a mounting structure defining a rotational axis about which the central hub is rotatable when attached to a mounting member of the frame assembly. Each one of the wheels is approximately a common radial distance from the rotational axis of the central hub. Each one of the wheels is approximately evenly spaced with respect to each adjacent one of the wheels. A rotational axis of each one of the wheels extends generally parallel with the rotational axis of the central hub.

### FIELD OF THE DISCLOSURE

The disclosures made herein relate generally to manually powered cargo carrying apparatuses such as baby carriages, baby strollers, wheeled luggage carts, dolly carts, shopping carts and wheelchairs and, more particularly, to manually powered cargo carrying apparatuses that are configured for efficiently rolling over obstacles in a path of travel.

### BACKGROUND

The circular shape of a wheel assembly (i.e., a wheel and attached tire) allows it to move relatively easily across smooth flat surfaces. Given a suitably large wheel assembly diameter, a wheel assembly will readily roll over moderate sized discontinuities and obstacles as well as uneven or bumpy surfaces. However, in many instances, a relatively large wheel assembly diameter is undesirable in that it requires more space than a smaller wheel assembly, it is generally considerably more expensive than a smaller wheel and it still exhibits limitations with respect to climbing over the edge of abrupt obstacles that are similar in height to a radius of the wheel assembly.

When moving a manually-powered cargo carrying apparatus such as a baby carriage, a baby stroller, a wheeled luggage cart, a dolly cart, a shopping cart and a wheelchair on a surface with relatively large discontinuities (e.g., stairs, curbs, large cracks, etc), it is typically necessary to carry the apparatus up or over the discontinuities or to lift the front wheel assemblies of the apparatus over a relatively large discontinuity followed by lifting the rear wheel assemblies over the same discontinuity (i.e., walking the manually-powered cargo carrying apparatus over the discontinuity). The larger the wheel is the more likely the wheel assembly will rollover the discontinuity. These types of conventional approaches for walking or pushing a manually-powered cargo carrying apparatus over discontinuities can be awkward and dangerous, not to mention limit access to certain places.

Therefore, a wheeled assembly that overcomes shortcomings associated with conventional approaches for facilitating a cargo carrying apparatus such as a baby carriage, a stroller, a shopping cart or a wheelchair to traverse relatively large discontinuities in a path of travel would be useful and advantageous.

### SUMMARY OF THE DISCLOSURE

Embodiments of the present invention relate to manually powered cargo carrying apparatuses such as, but not limited to, baby carriages, baby strollers, wheeled luggage carts, dolly carts, shopping carts and wheelchairs. More specifically, embodiments of the present invention include one or more multi-wheel hub assemblies that have a structural configuration enabling it to roll on relatively smooth surfaces and to ‘walk’ over relatively large discontinuities/obstacles in a path of travel. In doing so, embodiments of the present invention advantageously overcomes one or more shortcomings associated with conventional approaches for facilitating a cargo carrying apparatus to traverse relatively large discontinuities in a path of travel.

In one embodiment of the present invention, a multi-wheel hub assembly comprises a central hub and at least three wheels rotatably attached to the central hub. The central hub is configured for being rotatably attached to a support assembly. The central hub includes a mounting structure defining a rotational axis about which the central hub is rotatable when attached to a mounting member of the frame assembly. Each one of the wheels is approximately a common radial distance from the rotational axis of the central hub. Each one of the wheels is approximately evenly spaced with respect to each adjacent one of the wheels. A rotational axis of each one of the wheels extends generally parallel with the rotational axis of the central hub.

In another embodiment of the present invention, a cargo-carrying apparatus comprises a support assembly configured for supporting at least one cargo item and a plurality of multi-wheel hub assemblies attached to the support assembly. Each one of the multi-wheeled hub assemblies includes a central hub rotatably attached to the support assembly and at least three wheels rotatably attached to the central hub. The central hub of each one of the multi-wheel hub assemblies rotates about a respective rotational axis thereof. Each one of the wheels of a respective one of the multi-wheel hub assemblies is approximately a common radial distance from the rotational axis of the respective one of the multi-wheel hub assemblies. Each one of the wheels of a respective one of the multi-wheel hub assemblies is approximately evenly spaced with respect to each adjacent one of the wheels of the respective one of the multi-wheel hub assemblies. A rotational axis of each one of the wheels of a respective one of the multi-wheel hub assemblies extends generally parallel with the rotational axis of the respective one of the central hubs.

In another embodiment of the present invention, a cargo-carrying apparatus comprises a support assembly configured for engaging a body of a person for at least partially supporting the body and four multi-wheel hub assemblies attached to the support assembly. Each one of the multi-wheeled hub assemblies includes a central hub rotatably attached to the support assembly and five wheels rotatably attached to the central hub. The central hub of each one of the multi-wheel hub assemblies rotates about a respective rotational axis thereof. Each one of the wheels of a respective one of the multi-wheel hub assemblies is approximately a common radial distance from the rotational axis of the respective one of the multi-wheel hub assemblies. Each one of the wheels of a respective one of the multi-wheel hub assemblies is approximately evenly spaced with respect to each adjacent one of the wheels of the respective one of the multi-wheel hub assemblies. A rotational axis of each one of the wheels of a respective one of the multi-wheel hub assemblies extends generally parallel with the rotational axis of the respective one of the central hubs.

Turning now to specific aspects of the present invention, in at least one embodiment, the central hub includes a plurality of elongated arms each connected at a first end portion thereof to a main body portion of the central hub and each one of the wheels is attached to a second end portion of a respective one of the elongated arms.

In at least one embodiment of the present invention, all of the wheels lie substantially in a common plane.

In at least one embodiment of the present invention, all of the arms extend from a side face of the main body portion of the central hub.

In at least one embodiment of the present invention, the main body portion of the central hub is generally circular, the side face of the main body portion of the central hub defines an outer edge of the main body portion of the central hub, the common radial distance from the rotational axis of the central hub is at least about 75% of an outside diameter of the main body portion of the central hub and a minimum space between adjacent ones of the arms is greater than a maximum width of each one of the arms.

In at least one embodiment of the present invention, the support assembly includes a frame and a support structure attached to the frame, the multi-wheel hub assemblies are rotatably attached to the frame, the support structure is configured for supporting at least one cargo item.

In at least one embodiment of the present invention, a first one and a second one of the multi-wheel hub assemblies are in side-to-side spaced apart relationship with respect to each other, a third one and a fourth one of the multi-wheel hub assemblies are in side-to-side spaced apart relationship with respect to each other and the first one and the second one of the multi-wheel hub assemblies are laterally spaced part from the third one and the fourth one of the multi-wheel hub assemblies.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is an embodiment of a multi-wheel hub assembly in accordance with the present invention.

FIG. 2 is an embodiment of a manually powered cargo carrying apparatuses in accordance with the present invention.

### DETAILED DESCRIPTION OF THE DRAWING FIGURES

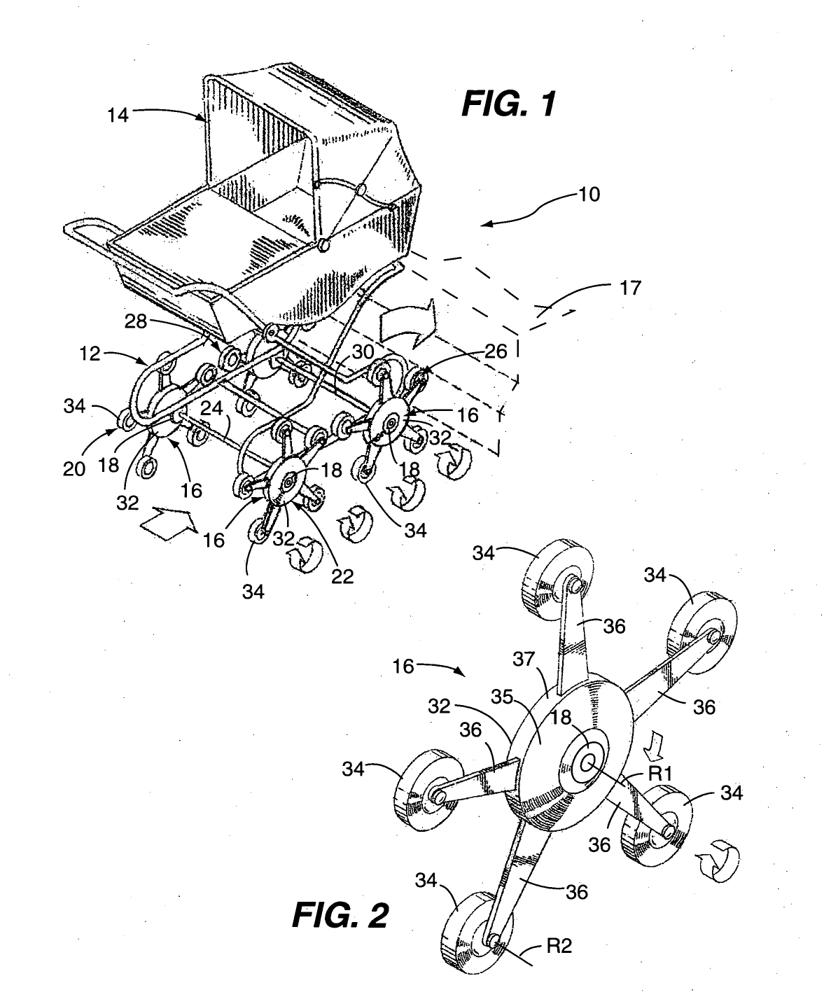

FIG. 1 shows an embodiment of a baby carriage in accordance with the present invention, which is referred to herein as the baby carriage 10. The baby carriage 10 is one embodiment of a manually-powered, cargo-carrying apparatus in accordance with the present invention. Other manually-powered, cargo-carrying apparatus configurable in accordance with the present invention include, but are not limited to, baby strollers, wheeled luggage carts, dolly carts, shopping carts and wheelchairs.

The baby carriage 10 includes a frame assembly 12, a support structure 14 and a plurality of multi-wheel hub assemblies 16. The support structure 14 is attached to the frame assembly 12 and is configured for supporting a baby (i.e., at least one cargo item). Other embodiments of support structures include, but are not limited to, that of a baby stroller, a wheeled luggage cart, a dolly cart, a shopping cart and a wheelchair. Each one of the multi-wheel hub assemblies 16 includes a mounting structure 18 that is rotatably engaged with a respective axle member of the frame assembly 12. The frame assembly 12 and the support structure 14 jointly define a support assembly configured for supporting a baby.

In accordance with the present invention, conventional wheels of a conventional manually-powered, cargo-carrying apparatus are replaced with the multi-wheel hub assemblies 16 disclosed herein. As is discussed below in greater detail, the structure and resulting functionality of the multi-wheel hub assemblies 16 allows the manually-powered, cargo-carrying apparatus (e.g., the baby carriage 10) to be pushed on flat terrain and to be readily ‘walked’ over obstacles such as the stairs 17 depicted in FIG. 1 or other obstacles.

The mounting structure 18 of a first multi-wheel hub assembly 20 and the mounting structure 18 of a second multi-wheel hub assembly 22 are rotatably attached to a rear axle member 24 (i.e., a mounting shaft) of the frame assembly 12. The rear axle member 24 is configured such that the first multi-wheel hub assembly 20 and the second multi-wheel hub assembly 22 are in side-to-side spaced apart relationship with respect to each other. The mounting structure 18 of a third multi-wheel hub assembly 26 and the mounting structure 18 of a fourth multi-wheel hub assembly 28 are rotatably attached to a front axle member 30 (i.e., a mounting shaft) of the frame assembly 12. The front axle member 30 is configured such that the third multi-wheel hub assembly 26 and the fourth multi-wheel hub assembly 28 are in side-to-side spaced apart relationship with respect to each other. The rear axle member 24 and the front axle member 30 extend generally parallel to each other such that the first and second multi-wheel hub assemblies (20, 22) are laterally spaced part from the third and third multi-wheel hub assemblies (26, 28).

Referring now to FIGS. 1 and 2, the hub assembly 10 includes a central hub 32 and five (5) wheels 34. The central hub 32 includes the mounting structure 18 that is configured for enabling the central hub 32 to be rotatably attached to respective axle member (24, 30) of the frame assembly 12. In one specific embodiment, as depicted in FIG. 1, the mounting structure 16 includes a passage 18 that is configured for receiving a respective one of the axle members (24, 30). The mounting structure 16 defines a rotational axis R1 about which the central hub 32 rotates when attached to the respective axle structure (24, 30).

The central hub 32 includes a main body portion 35 and a plurality of elongated arms 36. Each one of the elongated arms 36 is connected at a first end portion thereof to a side face 37 (FIG. 2) of the main body portion 35. Each one of the wheels 34 is attached to a second end portion of a respective one of the elongated arms 36. Each one of the wheels 34 is approximately a common radial distance from the rotational axis of the central hub 32 and each one of the wheels 34 is approximately evenly spaced with respect to each adjacent one of the wheels 34 (i.e., approximately 72 degrees between adjacent wheels 34). A rotational axis R2 of each one of the wheels 34 extends generally parallel with the rotational axis of the central hub 32.

The multi-wheel hub assemblies 16 each have a number of features that are preferred, but not necessary. All of the wheels 34 lie substantially in a common plane. The main body portion 35 of the central hub 32 is generally circular. The side face 37 of the main body portion 35 of the central hub 32 defines an outer edge of the main body portion 35. The common radial distance from the rotational axis R1 of the central hub 32 is at least about 75% of an outside diameter of the main body portion 35 of the central hub 32. A minimum space between adjacent ones of the arms 36 is greater than a maximum width of each one of the arms 36.

Referring to FIGS. 1 and 2, operation of the present invention is discussed. The multi-wheel hub assemblies 16 enable the baby carriage 10 to be pushed on flat terrain and to be readily ‘walked’ over terrain that is bumpy or sandy and over terrain that includes obstacles such as the stairs 17 depicted in FIG. 1 or other obstacles. Each one of the wheels 34 of a respective multi-wheel hub assemblies 16 rotates independently of the others. Furthermore, each central hub 32 is rotatably mounted to the baby carriage 10. Accordingly, when a wheel 34 is rolling on a surface and hits an essentially immovable object (e.g., on the steps 17), the central hub 32 rotates such that an adjacent wheel 34 rotates into contact with or over the immovable object. This rotating action transfers the load from the wheel 34 that was previously rolling to the adjacent wheel, thus providing for a walking action. Accordingly, the multi-wheel hub assemblies 16 enable the baby carriage 10 to be simply ‘walked’ over objects that would otherwise require the baby carriage 10 to be carried over or cumbersomely pushed over.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A multi-wheel hub assembly, comprising:
a central hub configured for being rotatably attached to a frame assembly, wherein the central hub includes a mounting structure defining a rotational axis about which the central hub is rotatable when attached to a mounting member of the frame assembly;
at least three wheels rotatably attached to the central hub, wherein each one of said wheels is approximately a common radial distance from the rotational axis of the central hub, wherein each one of said wheels is approximately evenly spaced with respect to each adjacent one of said wheels and wherein a rotational axis of each one of said wheels extends generally parallel with the rotational axis of the central hub.

2. The multi-wheel hub assembly of claim 1 wherein:
the central hub includes a plurality of elongated arms each connected at a first end portion thereof to a main body portion of the central hub; and
each one of said wheels is attached to a second end portion of a respective one of said elongated arms.

3. The multi-wheel hub assembly of claim 2 wherein all of said wheels lie substantially in a common plane.

4. The multi-wheel hub assembly of claim 3 wherein all of said arms extend from a side face of the main body portion of the central hub.

5. The multi-wheel hub assembly of claim 4 wherein:
the main body portion of the central hub is generally circular;
the side face of the main body portion of the central hub defines an outer edge of the main body portion of the central hub;
the common radial distance from the rotational axis of the central hub is at least about 75% of an outside diameter of the main body portion of the central hub; and
a minimum space between adjacent ones of said arms is greater than a maximum width of each one of said arms.

6. A cargo-carrying apparatus, comprising:
a support assembly configured for supporting at least one cargo item; and
a plurality of multi-wheel hub assemblies attached to the support assembly, wherein each one of said multi-wheeled hub assemblies includes a central hub rotatably attached to the support assembly and at least three wheels rotatably attached to the central hub, wherein the central hub of each one of said multi-wheel hub assemblies rotates about a respective rotational axis thereof, wherein each one of said wheels is approximately a common radial distance from the rotational axis of a respective one of said multi-wheel hub assemblies, wherein each one of said wheels of a respective one of said multi-wheel hub assemblies is approximately evenly spaced with respect to each adjacent one of said wheels of the respective one of said multi-wheel hub assemblies and wherein a rotational axis of each one of said wheels of a respective one of said multi-wheel hub assemblies extends generally parallel with the rotational axis of the respective one of said central hubs.

7. The cargo-carrying apparatus of claim 6 wherein:
the central hub includes a plurality of elongated arms each connected at a first end portion thereof to a main body portion of the central hub; and
each one of said wheels is attached to a second end portion of a respective one of said elongated arms.

8. The cargo-carrying apparatus of claim 7 wherein all of said wheels lie substantially in a common plane.

9. The cargo-carrying apparatus of claim 8 wherein all of said arms extend from a side face of the main body portion of the central hub.

10. The cargo-carrying apparatus of claim 9 wherein:
the main body portion of the central hub is generally circular;
the side face of the main body portion of the central hub defines an outer edge of the main body portion of the central hub;
the common radial distance from the rotational axis of the central hub is at least about 75% of an outside diameter of the main body portion of the central hub; and
a minimum space between adjacent ones of said arms is greater than a maximum width of each one of said arms.

11. The cargo-carrying apparatus of claim 6 wherein:
the support assembly includes a frame and a support structure attached to the frame;
said multi-wheel hub assemblies are rotatably attached to the frame;
the support structure is configured for supporting at least one cargo item;
a first one and a second one of said multi-wheel hub assemblies are in side-to-side spaced apart relationship with respect to each other;
a third one and a fourth one of said multi-wheel hub assemblies are in side-to-side spaced apart relationship with respect to each other; and
the first one and the second one of said multi-wheel hub assemblies are laterally spaced part from the third one and the fourth one of said multi-wheel hub assemblies.

12. The cargo-carrying apparatus of claim 11 wherein:
the central hub includes a plurality of elongated arms connected at a first end portion thereof to a main body portion of the central hub;
each one of said wheels is attached to a second end portion of a respective one of said elongated arms;
all of said wheels lie substantially in a common plane;
all of said arms extend from a side face of the main body portion of the central hub;
the main body portion of the central hub is generally circular;
the side face of the main body portion of the central hub defines an outer edge of the main body portion of the central hub;
the common radial distance from the rotational axis of the central hub is at least about 75% of an outside diameter of the main body portion of the central hub; and
a minimum space between adjacent ones of said arms is greater than a maximum width of each one of said arms.

13. A cargo-carrying apparatus, comprising:
a support assembly configured for engaging a body of a person for at least partially supporting the body; and
four multi-wheel hub assemblies attached to the support assembly, wherein each one of said multi-wheeled hub assemblies includes a central hub rotatably attached to the support assembly and five wheels rotatably attached to the central hub, wherein the central hub of each one of said multi-wheel hub assemblies rotates about a respective rotational axis thereof, wherein each one of said wheels is approximately a common radial distance from the rotational axis one of a respective one of said multi-wheel hub assemblies, wherein each one of said wheels of a respective one of said multi-wheel hub assemblies is approximately evenly spaced with respect to each adjacent one of said wheels of the respective one of said multi-wheel hub assemblies and wherein a rotational axis of each one of said wheels of a respective one of said multi-wheel hub assemblies extends generally parallel with the rotational axis of the respective one of said central hubs.

14. The cargo-carrying apparatus of claim 13 wherein:
the central hub includes five elongated arms each connected at a first end portion thereof to a main body portion of the central hub; and
each one of said wheels is attached to a second end portion of a respective one of said elongated arms.

15. The cargo-carrying apparatus of claim 14 wherein all of said wheels lie substantially in a common plane.

16. The cargo-carrying apparatus of claim 15 wherein all of said arms extend from a side face of the main body portion of the central hub.

17. The cargo-carrying apparatus of claim 16 wherein:
the main body portion of the central hub is generally circular;
the side face of the main body portion of the central hub defines an outer edge of the main body portion of the central hub;
the common radial distance from the rotational axis of the central hub is at least about 75% of an outside diameter of the main body portion of the central hub; and
a minimum space between adjacent ones of said arms is greater than a maximum width of each one of said arms.

18. The cargo-carrying apparatus of claim 13 wherein:
the support assembly includes a frame and a support structure attached to the frame;
said multi-wheel hub assemblies are rotatably attached to the frame;
the support structure is configured for supporting at least one cargo item;
a first one and a second one of said multi-wheel hub assemblies are in side-to-side spaced apart relationship with respect to each other;
a third one and a fourth one of said multi-wheel hub assemblies are in side-to-side spaced apart relationship with respect to each other; and
the first one and the second one of said multi-wheel hub assemblies are laterally spaced part from the third one and the fourth one of said multi-wheel hub assemblies.

19. The cargo-carrying apparatus of claim 18 wherein:
the central hub includes five elongated arms each connected at a first end portion thereof to a main body portion of the central hub;
each one of said wheels is attached to a second end portion of a respective one of said elongated arms;
all of said wheels lie substantially in a common plane;
all of said arms extend from a side face of the main body portion of the central hub;
the main body portion of the central hub is generally circular;
the side face of the main body portion of the central hub defines an outer edge of the main body portion of the central hub;
the common radial distance from the rotational axis of the central hub is at least about 75% of an outside diameter of the main body portion of the central hub; and
a minimum space between adjacent ones of said arms is greater than a maximum width of each one of said arms.
